(19) United States
(12) Patent Application Publication
(10) Pub. No.: US 2010/0161469 A1
(43) Pub. Date: Jun. 24, 2010

(54) SYSTEMS AND METHODS FOR CHARGING AN ELECTRIC VEHICLE USING A WIRELESS COMMUNICATION LINK

(76) Inventor: Nathan Bowman Littrell, Gardnerville, NV (US)

Correspondence Address: JOHN S. BEULICK (17851);ARMSTRONG TEASDALE LLP, ONE METROPOLITAN SQUARE, SUITE 2600, ST. LOUIS, MO, 63102-2740, US

(21) Appl. No.: 12/341,946

(22) Filed: Dec. 22, 2008

(51) Int. Cl. G06F 17/30; G06Q 40/00

(52) U.S. Cl. 705/35; 705/39

(57) ABSTRACT

A method for delivering energy to an electric vehicle includes receiving, via a wireless connection, a unique identifier of the electric vehicle from a tag within the electric vehicle, determining an account associated with the identifier, delivering an amount of energy to the electric vehicle, and determining a transaction amount related to the amount of energy delivered to the electric vehicle at an energy delivery point.

### BACKGROUND OF THE INVENTION

The subject matter disclosed herein relates generally to distributing energy to electric vehicles and, more particularly, to identifying an electric vehicle for use in an energy distribution transaction.

As electric vehicles and/or hybrid electric vehicles gain popularity, an associated need to accurately manage delivery of electrical energy to them has increased. Moreover, a need to recognize revenue due to the utility that provides the energy has been created by the increased use of such vehicles.

At least some known transaction systems facilitate identifying a vehicle during a transaction via a radio frequency identification (RFID) tag that is read by an RFID reader. For example, some such systems read a prepaid RFID card carried within a vehicle to collect expressway tolls while the vehicle moves within a normal range of speed through a toll booth. The vehicle is identified based on the RFID card and a toll amount is deducted from an existing account.

Moreover, at least some known communication systems enable distribution of data, such as operating data, between a vehicle on-board computer and transponders that are located within the vehicle or remote to the vehicle. For example, transponders within the vehicle may communicate vehicular operating conditions to the on-board computer via RFID. Moreover, transponders remote to the vehicle may communicate toll booth information, service information, parking costs, and/or road conditions to the on-board computer via RFID.

Furthermore, at least some known transaction systems facilitate communicating transaction information between a vehicle-mounted interface and a remote transaction unit. For example, transaction information may be communicated between the vehicle-mounted interface system and a bank teller unit used to withdrawal and/or deposit funds to an account. Moreover, transaction information may be communicated between the vehicle-mounted interface system and a drive-through point-of-sale system used to purchase goods and/or services.

However, none of the above-described communication and/or transaction systems enable an energy distribution point to obtain a unique identifier of an electric vehicle for use in a transaction that includes delivering energy to the electric vehicle. As such, systems and methods that facilitate identifying an electric vehicle prior to delivering energy and/or recognizing revenue from the delivery of energy to electric vehicles is desirable.

### BRIEF DESCRIPTION OF THE INVENTION

This Brief Description is provided to introduce a selection of concepts in a simplified form that are further described below in the Detailed Description. This Brief Description is not intended to identify key features or essential features of the claimed subject matter, nor is it intended to be used as an aid in determining the scope of the claimed subject matter.

In one aspect, a method is provided for delivering energy to an electric vehicle. The method includes receiving, via a wireless connection, a unique identifier of the electric vehicle from a tag within the electric vehicle, determining an account associated with the identifier, delivering an amount of energy to the electric vehicle, and determining a transaction amount related to the amount of energy delivered to the electric vehicle at an energy delivery point.

In another aspect, a system is provided for providing energy delivery to an electric vehicle. The system includes an energy delivery point and a server system coupled to the energy delivery point. The energy delivery point is configured to wirelessly receive a unique identifier of the electric vehicle from a tag within the electric vehicle, and to deliver an amount of energy to the electric vehicle. The server system is configured to determine an account associated with the identifier, and to determine a transaction amount related to the amount of energy delivered to the electric vehicle at the energy delivery point.

In another aspect, an energy delivery point is provided for use with a system for delivering electrical energy to an electric vehicle. The energy delivery point is configured to receive a unique identifier from the electric vehicle via a wireless connection, deliver an amount of energy to the electric vehicle, and to meter the amount of energy delivered to the electric vehicle.

### BRIEF DESCRIPTION OF THE DRAWINGS

The embodiments described herein may be better understood by referring to the following description in conjunction with the accompanying drawings.

FIG. 1 is a simplified block diagram of an exemplary system for use in providing electricity to an electric vehicle;

FIG. 2 is an expanded block diagram of an exemplary embodiment of a system architecture of the system shown in FIG. 1; and

FIG. 3 is a flowchart illustrating an exemplary method for use in providing energy distribution to electric vehicle using the system shown in FIGS. 1 and 2.

### DETAILED DESCRIPTION OF THE INVENTION

In some embodiments, the term “electric vehicle” refers generally to a vehicle that includes one or more electric motors that are used for propulsion. Energy used to propel electric vehicles may come from various sources, such as, but not limited to, an on-board rechargeable battery and/or an on-board fuel cell. In one embodiment, the electric vehicle is a hybrid electric vehicle, which captures and stores energy generated by braking. Moreover, a hybrid electric vehicle uses energy stored in an electrical source, such as a battery, to continue operating when idling to conserve fuel. Some hybrid electric vehicles are capable of recharging the battery by plugging into a power receptacle, such as a general power outlet. Accordingly, the term “electric vehicle” as used herein may refer to a hybrid electric vehicle or any other vehicle to which electrical energy may be delivered, for example, via the power grid.

Radio frequency identification (RFID) is an identification method that uses devices such as RFID tags to store data and RFID readers to retrieve and/or read the data stored on the RFID tags. At least some RFID tags include two parts: an integrated circuit for storing and processing data, and an antenna for receiving and transmitting a signal containing the data. As is known, RFID tags may be passive, active, or semi-passive. Passive RFID tags do not require an internal power source and are only active when an RFID reader reads the stored data. Both active and semi-passive RFID tags require a power source. As described herein, the term “RFID tag” may refer to either a passive RFID tag or an active RFID tag. However, it should be understood by one skilled in the art that the methods and systems described herein may use semi-passive RFID tags and/or any combination of active, semi-passive, and passive RFID tags.

In some embodiments, the term “wireless communication” refers generally to a wireless connection that enables an energy delivery point to receive a unique identifier from a tag embedded within an electric vehicle. In some embodiments, the tag is embodied as an RFID tag and the identifier is received by the energy delivery point using an RFID communication protocol as described above. In other embodiments, the identifier may be encoded within a bar code that is read by a handheld device that communicates the identifier to an energy delivery point. Moreover, in still other embodiments, the identifier may be encoded within a passive tag that does not broadcast information embedded within the identifier but, rather, is read or scanned by a reader or scanner that is coupled to an energy delivery point. Still other embodiments may use an active wireless protocol such as an IEEE 802.11 connection, a ZigBee® connection, and/or a Bluetooth® connection (ZigBee is a registered trademark of ZigBee Alliance Corporation, San Ramon, Calif., and Bluetooth is a registered trademark of Bluetooth SIC, Inc., Bellevue, Wash.). However, it should be understood by one skilled in the art that the methods and systems described herein may use any wireless protocol to communicate a unique identifier between an electric vehicle and an energy delivery point for the purpose of identifying the electric vehicle.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

Although described in connection with an exemplary energy delivery system environment, embodiments of the invention are operational with numerous other general purpose or special purpose computing system environments or configurations. The energy delivery system environment is not intended to suggest any limitation as to the scope of use or functionality of any aspect of the invention. Moreover, the energy delivery system environment should not be interpreted as having any dependency or requirement relating to any one or combination of components illustrated in the exemplary operating environment. Examples of well known energy delivery systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more controllers, computers, or other devices. Aspects of the invention may be implemented with any number and organization of components or modules. For example, aspects of the invention are not limited to the specific computer-executable instructions or the specific components or modules illustrated in the figures and described herein. Alternative embodiments of the invention may include different computer-executable instructions or components having more or less functionality than illustrated and described herein.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQI Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

Technical effects of the systems and methods described herein include at least one of (a) receiving, via a wireless connection, a unique identifier of an electric vehicle from a tag embedded within the electric vehicle; (b) accessing a database and searching for the identifier in the database; (c) determining an account associated with the identifier based on the search results; (d) determining whether to approve or deny service to the electric vehicle; (e) delivering an amount of energy to the electric vehicle if approved; (f) metering the amount of energy delivered by the energy delivery point to the electric vehicle; (g) determining a transaction amount related to the amount of energy delivered to the electric vehicle by the energy delivery point; and (h) deducting the transaction amount from the account.

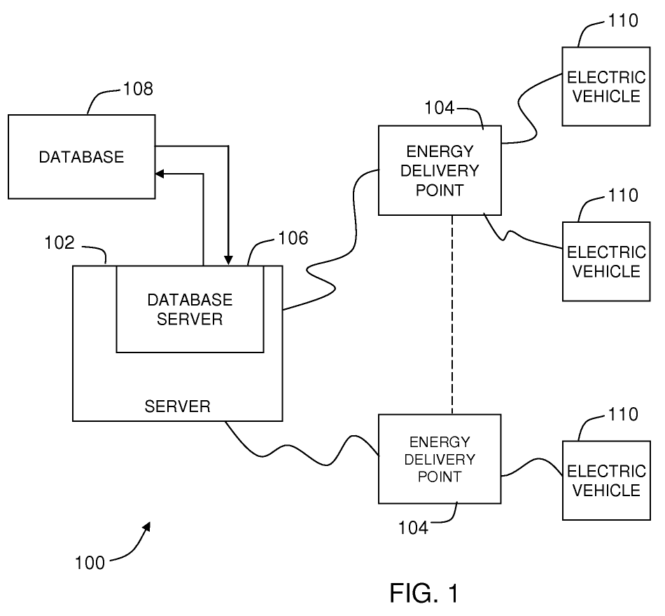

FIG. 1 is a simplified block diagram of an exemplary system 100 for providing energy to an electric vehicle 110. In the exemplary embodiment, system 100 includes a server system 102 and an energy delivery point 104 that is coupled to server system 102. As shown in FIG. 1, server system 102 may be coupled to a plurality of delivery points 104. In one embodiment, delivery points 104 include a network link (not shown in FIG. 1) that enables each delivery point 104 to access server system 102 over a network, such as the Internet and/or an intranet. Delivery points 104 are interconnected to the Internet and/or an intranet through many interfaces including a network, such as a local area network (LAN), a wide area network (WAN), dial-in-connections, cable modems, wireless modems, and/or special high-speed Integrated Services Digital Network (ISDN) lines. A database server 106 is connected to a database 108 containing information on a variety of matters, such as account information related to electric vehicle energy distribution. In one embodiment, centralized database 108 is stored on server system 102 and is accessed directly via at least one delivery point 104. In an alternative embodiment, database 108 is stored remotely from server system 102 and may be non-centralized.

Moreover, in the exemplary embodiment, each delivery point 104 is capable of providing energy, such as electrical energy, to one or more electric vehicles 110. Each electric vehicle 110 stores the energy therein and uses the stored energy for propulsion, rather than, or in addition to, more conventional energy sources, such as gasoline.

As described in more detail below, each electric vehicle 110 includes a unique identifier that is used by delivery point 104 and/or server 102 to identify that electric vehicle 110 and/or an account associated with electric vehicle 110. For example, database 108 may include transactional and/or accounting data related to prepayment information associated with an amount of energy that has been paid for in advance for later distribution to electric vehicle 110. Moreover, database 108 may include historical energy distribution data, such as transaction dates, and/or an amount of energy delivered to electric vehicle 110 for each transaction. Further, database 108 may include historical payment information, such as prepayment dates and/or prepayment amounts.

The embodiments illustrated and described herein as well as embodiments not specifically described herein, but within the scope of aspects of the invention constitute exemplary means for providing metering of energy distribution for an electric vehicle, and more particularly, exemplary means for identifying an electric vehicle using wireless communication and providing energy distribution and metering for the electric vehicle. For example, server system 102 or delivery point 104, or any other similar computer device that is programmed with computer-executable instructions as illustrated in FIG. 1, provides exemplary means for identifying an electric vehicle using a wirelessly communicated identifier.

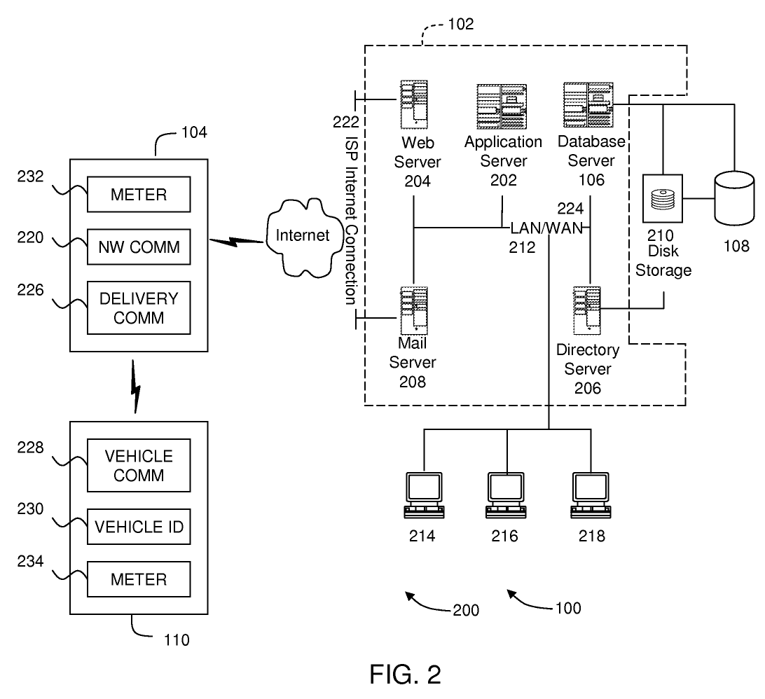

FIG. 2 is an expanded block diagram of an exemplary embodiment of a system architecture 200 of system 100 (shown in FIG. 1). Components in system architecture 200, identical to components of system 100, are identified in FIG. 2 using the same reference numerals used in FIG. 1. In the exemplary embodiment, system 200 includes server system 102 and energy delivery points 104. Server system 102 also includes database server 106, an application server 202, a web server 204, a directory server 206, and a mail server 208. A disk storage unit 210 is coupled to database server 106 and directory server 206. Examples of disk storage unit 210 may include, but are not limited to only including, a Network Attached Storage (NAS) device and a Storage Area Network (SAN) device. Database server 106 is also coupled to database 108. Servers 106, 202, 204, 206, 206, and 208 are coupled in a local area network (LAN) 212. Moreover, a system administrator workstation 214, a user workstation 216, and a supervisor workstation 218 may be coupled to LAN 212 to enable communication with server system 102. Alternatively, workstations 214, 216, and 218 may be coupled to LAN 212 using an Internet link or may be coupled through an intranet. In one embodiment, an owner or user of electric vehicle 110 may access server system 202 via web server 204 to access, for example, the user's account and/or a payment service that enables the user to pay for energy that has been delivered to electric vehicle 110 or will be delivered to electric vehicle 110. Moreover, in one embodiment, mail server 208 may be configured to send a message, such as an email message, to the user when the user's account balance falls below a predetermined threshold. Alternatively, a user may setup a periodic reminder, wherein mail server 208 transmits a message to the user at a configurable periodic rate or when the account balance reaches a predetermined threshold value as a reminder to prepay for energy to be delivered later to electric vehicle 110.

Each energy delivery point 104 includes a network communication module 220 that communicates with server system 102. For example, server system 102 is configured to be communicatively coupled to energy delivery points 104 to enable server system 102 to be accessed using an Internet connection 222 provided by an Internet Service Provider (ISP). The communication in the exemplary embodiment is illustrated as being performed using the Internet, however, any suitable wide area network (WAN) type communication can be utilized in alternative embodiments. More specifically, the systems and processes are not limited to being practiced using only the Internet. In addition, local area network 212 may be used, rather than WAN 224. Each energy delivery point 104 also includes a delivery point communication module 226 that enables energy delivery point 104 to communicate with one or more electric vehicles 110. In addition, local area network 212 may be used rather than WAN 224.

Moreover, in the exemplary embodiment, energy delivery points 104 are electrically and/or communicatively coupled to one or more electric vehicles 110. Each electric vehicle 110 includes a vehicle communication module 228 that enables electric vehicle 110 to communicate with energy delivery point 104. More specifically, vehicle communication module 228 enables electric vehicle 110 to acquire energy from energy delivery point 104 via delivery point communication module 226.

To facilitate communication between electric vehicle 110 and server system 102 via energy delivery point 104, electric vehicle 110 includes a unique vehicle identifier 230 that is embedded within electric vehicle 110. In the exemplary embodiment, identifier 230 is implemented as a radio frequency identification (RFID) tag. As described above, the RFID tag may be a passive RFID tag or an active RFID tag. However, it should be understood by one skilled in the art that the methods and systems described herein may use semi-passive RFID tags and/or any combination of active, semi-passive, and passive RFID tags. In one embodiment, identifier 230 is a passive RFID tag that is scanned by an REID reader coupled to or provided within energy delivery point 104 in order to determine the identity of electric vehicle 110. In an alternative embodiment, identifier 230 is an active RFID tag that emits the identity of electric vehicle 110 such that an RFID receiver coupled to or provided within energy delivery point 104 receives identifier 230. In further alternative embodiments, identifier 230 may be transmitted or read using any other wirelessly communication protocol. For example, identifier 230 may be encoded in a barcode and read by a handheld scanner that transmits identifier 230 to energy delivery point 104. In another embodiment, identifier 230 may be communicated using a passive or an active wireless communication protocol, such as an 802.11 connection and/or a Bluetooth® connection.

In the exemplary embodiment, identifier 230 is linked in database 108 to an account associated with electric vehicle 110, in which an account balance is maintained including prepayments that are made to the account by the account owner. Alternatively, identifier 230 may be linked to an account that is associated with a person, such that an account balance allocated among one or more electric vehicles 110. Further, in the exemplary embodiment, each energy delivery point 104 includes an energy meter 232 that tracks an amount of energy delivered to electric vehicle 110. Moreover, electric vehicle 104 includes an energy meter 234 that tracks an amount of energy received by electric vehicle 110.

During use, when a customer wishes to charge electric vehicle 110 via energy delivery point 104, electric vehicle 110 is recognized by energy delivery point 104 according to identifier 230. More specifically, in one embodiment, energy delivery point 104 reads identifier 230 using, for example, an RFID reader, where identifier 230 is a passive RFID chip. Alternatively, energy delivery point 104 receives identifier 230 using, for example, an RFID receiver, where identifier 230 is an active RFID chip. Energy delivery point 104 then transmits identifier 230 to server system 102 in order to determine an account associated with identifier 230. In alternative embodiments, energy delivery point 104 receives identifier 230 using a different wireless communication protocol, such as those described above.

In the exemplary embodiment, and once server system 102 has identified an account associated with identifier 230, server system 102 determines an account balance. If the account balance meets a predetermined threshold, server system 102 instructs energy delivery point 104 to enable service to electric vehicle 110. If the account balance does not meet a predetermined threshold, server system 102 may instruct energy delivery point 104 to deny service to electric vehicle 110 and display a message to the customer stating the reason for the denial. In such a case, server system 102 may issue a temporary credit to the account balance. In one embodiment, energy delivery point 104 meters energy delivery to electric vehicle using a different rate, such as a higher rate, when a temporary credit is issued. In an alternative embodiment, server system 102 may instruct energy delivery point 104 to deny service to electric vehicle 110 when the account associated with identifier 230 has been put into a hold state. A hold state may be placed on the account based on, for example, a delinquent payment by the customer and/or a report of electric vehicle 110 being stolen. In the exemplary embodiment, when service to electric vehicle 110 is enabled, energy delivery point 104 will deliver an amount of energy to electric vehicle 110. During the delivery, both energy delivery point 104 and electric vehicle 110 meter the amount of energy delivered and/or a transaction amount related to the amount of energy delivered, via delivery point meter 232 and vehicle meter 234, respectively. A final transaction amount is determined at the conclusion of the energy delivery, and the final transaction amount is transmitted to server system 102. Server system 102 then deducts the final transaction amount from the account balance. If the final transaction amount is greater than the account balance, server system 102 may issued a temporary credit using a different rate, such as a higher rate, as described above. In addition, in one embodiment, upon the conclusion of energy delivery, delivery point meter 232 and vehicle meter 234 compare the amount of energy delivered and/or the final transaction amount. If the comparison results in a match, then vehicle meter 234 generates a receipt. In one embodiment, the receipt is stored in vehicle meter 234. In another embodiment, the receipt is also transmitted to energy delivery point 104 for storage in server system 102. This comparison facilitates ensuring that the correct amount of energy delivered and/or the correct transaction amount is billed to the account and/or deducted from the account balance. Moreover, the comparison facilitates ensuring that, if there are multiple electric vehicles 110 receiving energy from energy delivery point 104, the correct account is billed.

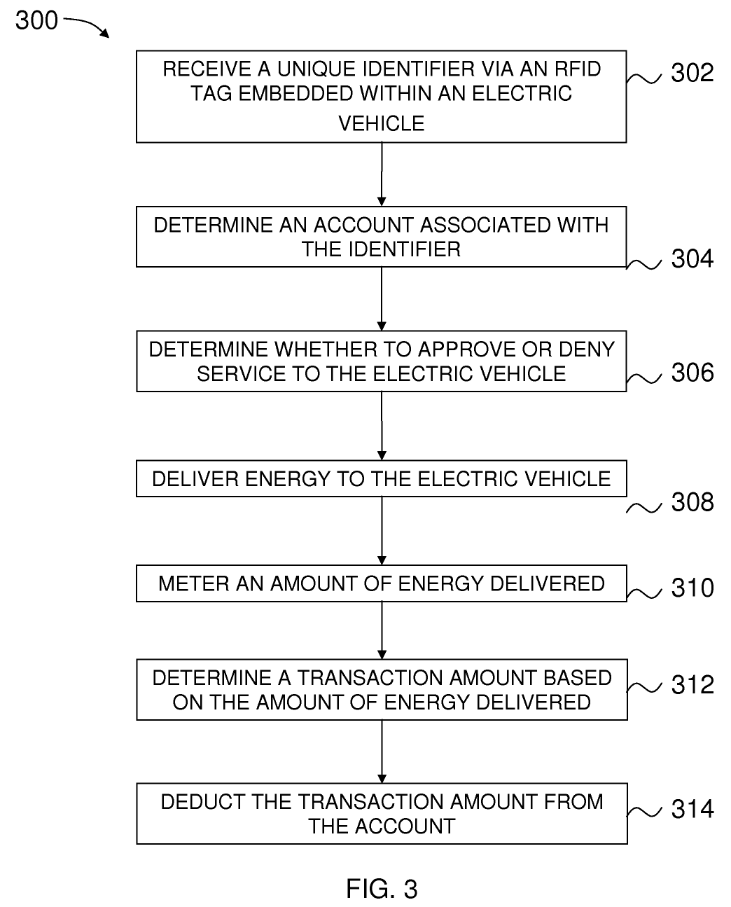

FIG. 3 is a flowchart 300 illustrating an exemplary method for providing delivery of energy to electric vehicle 110 (shown in FIGS. 1 and 2). In the exemplary embodiment, energy delivery point 104 (shown in FIGS. 1 and 2) receives 302 a unique identifier 230 (shown in FIG. 2) from a tag embedded in electric vehicle 110. In one embodiment, identifier 230 is stored in a passive RFID tag and energy delivery point 104 includes an RFID reader configured to read identifier 230. In an alternative embodiment, identifier 230 is stored in an active RFID tag and energy delivery point 104 includes an RFID receiver configured to receiver identifier 230 from the active RFID tag once electric vehicle 110 is positioned within a receiving range of the RFID receiver. In still other embodiments, energy delivery point 104 receives identifier 230 using a wireless communication protocol other than RFID, such as by using a bar code reader, an 802.11 connection, and/or a Bluetooth® connection. In the exemplary embodiment, electric vehicle 110 and, more specifically, identifier 230, is associated with a customer account. Energy delivery point 104 then transmits the identifier 230 to server system 102 (shown in FIGS. 1 and 2). Server system 102 determines 304 an account associated with identifier 230. More specifically, energy delivery point 104 transmits identifier 230 to server system 102 using, for example, the Internet and/or an intranet. Server system 102 determines the user account associated with identifier 230 within database 108 (shown in FIGS. 1 and 2).

When identifier 230 has been read, a current balance of the customer account associated with identifier 230 is determined. In one embodiment, server system 102 then determines 306 whether to approve or deny energy delivery from energy delivery point 104 to electric vehicle 110. For example, if the current balance is less than a threshold amount, the customer is denied service at energy delivery point 104. In such an embodiment, the customer may also be prompted to insert a credit card or cash into a card reader within energy delivery point 104. As another example, service may be denied by server system 102 due to a stolen car report associated with electric vehicle 110. In the exemplary embodiment, the current account balance may be increased by the account owner remotely using, for example, user workstation 216 (shown in FIG. 2). For example, the customer may login to server system 202 via user workstation 216 in order to access a payment program that enables the customer to designate a payment amount to be applied to the account balance. The customer also designates a payment source including, but not limited to only including, a credit card, a debit card, and/or a banking account. The payment amount is then credited to the account balance.

In the exemplary embodiment, an amount of energy is delivered 308 to electric vehicle 110 by energy delivery point 104 and the amount of energy delivered is metered 310. A transaction amount is determined 312 based on an actual amount of energy delivered to electric vehicle 110 at energy delivery point 104. More specifically, delivery point meter 232 (shown in FIG. 2) meters the amount of energy delivered. In one embodiment, energy delivery point 104 determines a transaction amount based on the amount of energy delivered and transmits the transaction amount to server system 102. In an alternative embodiment, energy delivery point 104 transmits the amount of energy delivered to server system 102, and server system 102 determines the transaction amount based on the amount of energy delivered. In the exemplary embodiment, the transaction amount is then compared to the current balance in the customer account. If the transaction amount is less than the current balance, the transaction amount is deducted 314 from the current balance. The new balance is then stored in database 108. In one embodiment, the new balance is transmitted by server system 102 to energy delivery point 104 and displayed to the customer. In an alternative embodiment, the new balance is also transmitted to electric vehicle 110 by energy delivery point 104 and displayed to the customer via vehicle meter 234. If the current balance is less than the transaction amount, the customer account may be credited with the difference between the transaction amount and the current balance and the customer billed for the difference at a later time. In such an embodiment, the billing rate may be changed for any energy distributed on credit. Alternatively, the customer may be prompted to submit payment at energy delivery point 104. For example, the customer may be prompted to insert a credit card into a card reader within energy delivery point 104. In the exemplary embodiment, a confirmation of the receipt of the delivered energy is generated 308 by vehicle meter 234. The receipt may be used by the customer to verify an amount of energy delivered and/or a cost per unit energy. The receipt may be generated by electric vehicle 110 and stored in electric vehicle 110 and database 108. Alternatively, the receipt may be generated by server system 102, stored in database 108, and transmitted to electric vehicle 110 via energy delivery point 104. In addition, in one embodiment, an adjusted current balance may be displayed to the customer via energy delivery point 104 to reflect a deduction of the transaction amount from the account.

Described in detail herein are exemplary embodiments of methods, systems, and computers that facilitate delivering energy to vehicles, such as electric vehicles. More specifically, the embodiments described herein facilitate identifying an electric vehicle at an energy delivery point using a unique identifier embedded within the electric vehicle. Wirelessly identifying an electric vehicle facilitates automatic deduction of a transaction amount from an account. Such an automatic deduction facilitates time savings for a customer and greater ease in collecting revenue for an energy distribution utility.

The methods and systems described herein are not limited to the specific embodiments described herein. For example, components of each system and/or steps of each method may be used and/or practiced independently and separately from other components and/or steps described herein. In addition, each component and/or step may also be used and/or practiced with other assembly packages and methods.

While the invention has been described in terms of various specific embodiments, those skilled in the art will recognize that the invention can be practiced with modification within the spirit and scope of the claims.

What is claimed is:

1. A method for delivering energy to an electric vehicle, said method comprising:
receiving, via a wireless connection, a unique identifier of the electric vehicle from a tag within the electric vehicle;
determining an account associated with the identifier;
delivering an amount of energy to the electric vehicle; and
determining a transaction amount related to the amount of energy delivered to the electric vehicle at an energy delivery point.

2. A method in accordance with claim 1, wherein the tag is a passive RFID tag, said receiving a unique identifier comprises scanning the RFID tag using an RFID reader within the energy delivery point.

3. A method in accordance with claim 1, wherein the tag is an active RFID tag, said receiving a unique identifier comprises transmitting, by the RFID tag, the identifier to an RFID receiver within the energy delivery point.

4. A method in accordance with claim 1, wherein determining an account comprises:
accessing a database;
searching for the identifier in the database; and
determining the account based on the search results.

5. A method in accordance with claim 4, wherein determining an account further comprises transmitting the identifier from the energy delivery point to a server coupled to the database.

6. A method in accordance with claim 1, wherein determining a transaction amount comprises metering the amount of energy delivered at the energy delivery point to the electric vehicle.

7. A method in accordance with claim 6, wherein metering the amount of energy delivered comprises metering, by at least one of the energy delivery point and the electric vehicle, the amount of energy delivered to the electric vehicle.

8. A method in accordance with claim 1, further comprising deducting the transaction amount from the account.

9. A system for providing energy delivery to an electric vehicle, said system comprising:
an energy delivery point configured to receive, via a wireless connection, a unique identifier of the electric vehicle from a tag within the electric vehicle, and deliver an amount of energy to the electric vehicle; and
a server system coupled to said energy delivery point, said server system configured to determine an account associated with the identifier, and determine a transaction amount based on the amount of energy delivered to the electric vehicle by said energy delivery point.

10. A system in accordance with claim 9, wherein the tag is a passive RFID tag, said energy delivery point comprises an RFID reader configured to scan the RFID tag in order to determine the identifier.

11. A system in accordance with claim 9, wherein the tag is an active RFID tag, said energy delivery point comprises an RFID receiver configured to receive the identifier from the RFID tag in order to determine the identifier.

12. A system in accordance with claim 9, wherein said energy delivery point is configured to transmit the identifier to said server system via a network.

13. A system in accordance with claim 12, wherein said server system comprises a database and a computer coupled to said database, said computer is configured to:
access said database;
search for the identifier in said database; and
determine the account based on the search results.

14. A system in accordance with claim 9, wherein said energy delivery point comprises a meter configured to determine an amount of energy delivered to the electric vehicle.

15. A system in accordance with claim 14, wherein said meter is further configured to transmit the amount of energy delivered to said server system, said server system is configured to determine the transaction amount based on the amount of energy delivered.

16. A system in accordance with claim 9, wherein said server system is configured to deduct the transaction amount from the account.

17. An energy delivery point for use with a system for delivering electrical energy to an electric vehicle, said energy delivery point configured to:
receive a unique identifier from the electric vehicle via a wireless connection;
deliver an amount of energy to the electric vehicle; and
meter the amount of energy delivered to the electric vehicle.

18. An energy delivery point according to claim 17, wherein said energy delivery point is further configured to transmit the identifier to a server to determine an account associated with the identifier.

19. An energy delivery point according to claim 17, wherein said energy delivery point is further configured to transmit, to a server, the amount of energy delivered to the electric vehicle to determine a transaction amount.

20. An energy delivery point according to claim 17, wherein said energy delivery point is further configured to compare the metered amount of energy delivered with a metered value determined by the electric vehicle.
